(19) United States
(12) Patent Application Publication
(10) Pub. No.: US 2025/0315036 A1
(43) Pub. Date: Oct. 9, 2025

(54) ACTIVE DISTURBANCE REJECTION CONTROL METHOD AND SYSTEM BASED ON ERROR-COMPENSATED EXTENDED STATE OBSERVER

(71) Applicant: ZJU-HANGZHOU GLOBAL SCIENTIFIC AND TECHNOLOGICAL INNOVATION CENTER, Hangzhou (CN)

(72) Inventors: Chen YANG, Hangzhou (CN); Yuanliu CHEN, Hangzhou (CN); Bingfeng JU, Hangzhou (CN)

(21) Appl. No.: 19/245,810

(22) Filed: Jun. 23, 2025

Related U.S. Application Data
(63) Continuation of application No. PCT/CN2023/125122, filed on Oct. 18, 2023.

(30) Foreign Application Priority Data
Dec. 23, 2022 (CN) 202211667823.0

(51) Int. Cl. G05B 19/418

(52) U.S. Cl. CPC G05B 19/41885; G05B 2219/24015

(57) ABSTRACT

An active disturbance rejection control method and system based on an error-compensated extended state observer. The method includes: allowing a linear active disturbance rejection controller to acquire an input signal and first output states of an extended state observer and output a first control signal; constructing a state space model of the extended state observer for output displacement, converting a controlled plant into an integrator-chain form, and obtaining an output displacement signal based on the controlled plant; inputting the output displacement signal and a control input signal to the extended state observer to obtain second output states; and then feeding the second output states back to the linear active disturbance rejection controller and the state space model.

### CROSS-REFERENCE TO RELATED APPLICATIONS

This application is a continuation of international patent application No. PCT/CN2023/125122, filed on Oct. 18, 2023, which itself claims priority to Chinese Patent Application No. 202211667823.0, filed on Dec. 23, 2022. The contents of the above identified applications are hereby incorporated herein in their entireties by reference.

### TECHNICAL FIELD

The present disclosure relates to the field of control technologies, and in particular, to an active disturbance rejection control method and system based on an error-compensated extended state observer.

### BACKGROUND

A nanometer positioning platform driven by a piezoelectric actuator is a core device in precision engineering and is widely applied to atomic force microscopes, micro-nano manufacturing and precision servo systems. With a rapid development of nanotechnology, requirements of actual demands for precision and a response speed of the nanometer positioning platform are continuously increased. However, inherent hysteresis and creep non-linear characteristics of a piezoelectric material can seriously affect positioning precision of the nanometer positioning platform. In addition, a low damping characteristic of the nanometer positioning platform causes an input signal to easily excite a low-order resonance mode of the nanometer positioning platform, resulting in oscillation of output displacement. A hysteresis effect and a mechanical resonance are coupled at a high frequency band to further reduce positioning precision. Although the nanometer positioning platform driven by the piezoelectric actuator has advantages of a high response speed, zero friction, high positioning precision and resolution, or the like, a further improvement of a performance is seriously hindered by existence of the above problems.

An extended state observer can estimate internal states and total disturbance of a system, and can compensate the displacement of the nanometer positioning platform in real time on this basis, thereby guaranteeing the positioning precision. However, a linear extended state observer widely adopted at present has the major problems that when the total disturbance of the system is completely unknown, a capability of the linear extended state observer to estimate the system state and disturbance depends heavily on a bandwidth of the linear extended state observer. Increasing the bandwidth of the linear extended state observer reduces the noise performance of the system and thus degrades the stability margin. Therefore, how to improve the estimation performance of the linear extended state observer within a limited bandwidth is a problem to be solved urgently. A solution of the above problem from a perspective of a control system is of great significance for practical application of the nanometer positioning platform.

### SUMMARY

According to various embodiments of the present disclosure, an active disturbance rejection control method and system based on an error-compensated extended state observer are provided.

The present disclosure provides an active disturbance rejection control method based on an error-compensated extended state observer, including the following steps: constructing an extended state observer based on a state space model of a controlled plant; allowing a linear active disturbance rejection controller to acquire an input signal and output states of the extended state observer and output a first control signal; converting the controlled plant into an integrator-chain form based on the first control signal, a total disturbance signal, and an estimation error of the extended state observer, and obtaining an output displacement signal based on the controlled plant; inputting the output displacement signal and the input signal to the extended state observer, and outputting second output states of the extended state observer; and feeding the second output states back to the linear active disturbance rejection controller and the state space model of the controlled plant.

In an embodiment, constructing the extended state observer based on the state space model of the controlled plant includes the following steps: acquiring the first control signal and the total disturbance signal, and determining an output displacement of a nanometer positioning platform; constructing the corresponding extended state observer based on the output displacement, the system order, and the first control signal, and obtaining relevant parameters and bandwidth of the extended state observer; combining the first output states of the extended state observer with the input signal to obtain a third control signal; combining the output displacement of the nanometer positioning platform with a first estimation state of the extended state observer to obtain an estimation error of the extended state observer about a first state; combining the estimation error of the first state with the third control signal to obtain a second control signal; combining the second control signal with the total disturbance signal to obtain the first control signal; and performing Laplace transform on an error equation set of the first state of the extended state observer to obtain a frequency domain expression of the estimation error of the first state of the extended state observer.

In an embodiment, the state space model of the controlled plant is represented as: y⁽ⁿ⁾=f+b₀u, y represents the output displacement, u represents the first control signal, f represents the total disturbance signal, and b₀ represents a gain of the first control signal.

In an embodiment, an actual state of the controlled plant is defined as the output displacement and derivatives of all orders of the output displacement, which are represented as x₁=y, . . . , xₙ=y⁽ⁿ⁻¹⁾, xₙ₊₁=f, the corresponding extended state observer is then represented as:

$$\{ \begin{matrix}{\dot{z}}_{1} = {z}_{2} + {l}_{1} ( y - {z}_{1} ) \\ ⋮ \\ {\dot{z}}_{n} = {z}_{n + 1} + {l}_{n} ( y - {z}_{1} ) + bu \\ {\dot{z}}_{n + 1} = {l}_{n + 1} ( y - {z}_{1} ) \\ \hat{y} = {z}_{1}\end{matrix}$$

ŷ represents an estimation of the output displacement, f represents the total disturbance signal, zᵢ(i=1 . . . n+1) represents first output states of the extended state observer,

$${l}_{i} = \frac{( n + 1 ) !}{i ! ( n + 1 - i ) !} {ω}_{o}^{i}$$

represents a parameter of the extended state observer, ωₒ represents a bandwidth of the extended state observer, u represents the first control signal, and when ωₒ approaches a preset threshold, the first output states of the extended state observer approaches the actual state of the controlled plant, that is, zᵢ→xᵢ(i=1 . . . n).

In an embodiment, it is assumed that the first control signal is represented as:

$$u = ( {u}_{0} - \hat{f} ) / {b}_{0}$$

u₀ represents the second control signal, \hat{f} represents an estimated value of the total disturbance signal f, and b₀ represents a gain of the first control signal. A first output displacement is obtained in conjunction with the state space model, and the first output displacement is represented as:

$${y}^{( n )} = {u}_{o} + {d}_{1} = {u}_{o} + f - \hat{f}$$

d₁ represents residual disturbance, the estimation error of the first state related to the output displacement is as follows:

$${e}_{1}^{( n )} = - {l}_{1} {e}_{1}^{( n - 1 )} - {l}_{2} {e}_{1}^{( n - 2 )} - … - {l}_{n} {e}_{1} + {d}_{1}$$

Laplace transform is performed on the estimation error of the first state to obtain transfer function between the estimation error of the first state and residual disturbance:

$${E}_{1} ( s ) = \frac{{D}_{1} ( s )}{{s}^{n} + {l}_{1} {s}^{n - 1} + {l}_{2} {s}^{n - 2} + … + {l}_{n}} ,$$

E₁(s) and D₁(s) represent Laplace transform of e₁ and d₁, respectively, and Lₙe₁ represents a low frequency approximation of the residual disturbance d₁.

In an embodiment, the linear active disturbance rejection controller with error-compensated extended state observer is represented as:

$${u}^{′} = \frac{{k}_{1} ( r - {z}_{1} ) - {k}_{2} {z}_{2} - … - {k}_{n} {z}_{n} - {l}_{n} {e}_{1}}{{b}_{0}}$$

kᵢ(i=1 . . . n) represents a parameter of the linear active disturbance rejection controller, zᵢ(i=1 . . . n) represents each output state of the extended state observer, r represents the input signal of the linear active disturbance rejection controller, b₀ represents a gain of the first control signal, and lₙe₁ represents a low frequency approximation of a residual disturbance d₁.

In an embodiment, it is assumed that a second derivative of the output displacement y is represented as:

$$\ddot{y} = {\underbrace{{\dot{y}}^{3} + y + d}}_{f} + {u}^{′} ;$$

the linear active disturbance rejection controller with error-compensated extended state observer is represented as: u′=kₚ(r−z₁)−k_{d}z₂−l₂e₁ y represents the output displacement, \dot{y} represents a first derivative of the output displacement y, ÿ represents the second derivative of the output displacement y, kₚ=ω_{c}², k_{d}=2ω_{c}, ω_{c} represents a control bandwidth, the disturbance d includes a square wave signal, r represents the input signal of the linear active disturbance rejection controller, and z₁ and z₂ represent the output states of the extended state observer.

The present disclosure further provides an active disturbance rejection control system based on an error-compensated extended state observer, including: means for constructing an extended state observer based on a state space model of a controlled plant; allowing a linear active disturbance rejection controller to acquire an input signal and first output states of the extended state observer and output a first control signal; means for converting the controlled plant into an integrator-chain form based on the first control signal, a total disturbance signal, and an estimation error of the extended state observer, and obtaining an output displacement signal based on the controlled plant; means for inputting the output displacement signal and the input signal to the extended state observer, and outputting second output states of the extended state observer; and means for feeding the second output states back to the linear active disturbance rejection controller and the state space model of the controlled plant.

The present disclosure further provides a computer-readable storage medium storing a computer program which, when executed by a processor, implements the method as described above.

The present disclosure further provides an active disturbance rejection control apparatus based on an error-compensated extended state observer, including a memory, a processor, and a computer program stored in the memory and running on the processor. The processor implements the method as described above when executing the computer program.

Details of one or more embodiments of the present disclosure are set forth in the accompanying drawings and the description below. Other features, objects, and advantages of the present disclosure will be apparent from the description, the accompanying drawings, and the claims.

### BRIEF DESCRIPTION OF THE DRAWINGS

In order to illustrate the technical solutions in the embodiments of the present disclosure or the related art more clearly, the drawings required for describing the embodiments or the related art will be described briefly. Apparently, the following described drawings are merely for some embodiments of the present disclosure, and other drawings can be derived from these drawings by those of ordinary skill in the art without any creative effort.

FIG. 1 is a flowchart of an active disturbance rejection control method based on an error-compensated extended state observer in some embodiments.

FIG. 2 is a schematic diagram of a process for constructing an extended state observer in some embodiments.

FIG. 3 is a schematic detailed diagram of an extended state observer in some embodiments.

FIG. 4 is a schematic diagram of active disturbance rejection control based on an extended state observer in some embodiments.

FIG. 5 is a schematic diagram of control performance comparison based on an extended state observer in some embodiments.

FIG. 6 is a schematic diagram of a triangle wave tracking result of a nanometer positioning platform in some embodiments.

FIG. 7 is a structural block diagram of an active disturbance rejection control method based on an error-compensated extended state observer in some embodiments.

FIG. 8 is a schematic structural diagram of an electronic device in some embodiments.

FIG. 9 is an overall schematic diagram of an active disturbance rejection control system based on an error-compensated extended state observer in some embodiments.

### DETAILED DESCRIPTION

The technical solutions in the embodiments of the present disclosure are clearly and completely described with reference to the accompanying drawings in the embodiments of the present disclosure, and apparently, the described embodiments are not all but only a part of the embodiments of the present disclosure. All other embodiments obtained by one skilled in the art based on the embodiments of the present disclosure without creative efforts shall fall within the protection scope of the present disclosure.

### First Embodiment

An active disturbance rejection control method based on an error-compensated extended state

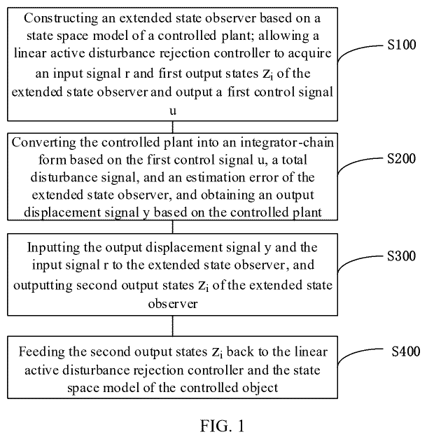

observer is provided, a relied structure may refer to FIG. 7, and referring to FIG. 1, the method includes step 100 to step 400.

Step 100 includes constructing an extended state observer based on a state space model of a controlled plant; allowing a linear active disturbance rejection controller to acquire an input signal r and first output states z; of the extended state observer and output a first control signal u.

Step 200 includes converting the controlled plant into an integrator-chain form based on the first control signal u, a total disturbance signal, and an estimation error of the extended state observer, and obtaining an output displacement signal y based on the controlled plant.

Step 300 includes inputting the output displacement signal y and the input signal r to the extended state observer, and outputting second output states zᵢ of the extended state observer.

Step 400 includes feeding the second output states zᵢ back to the linear active disturbance rejection controller and the state space model of the controlled plant.

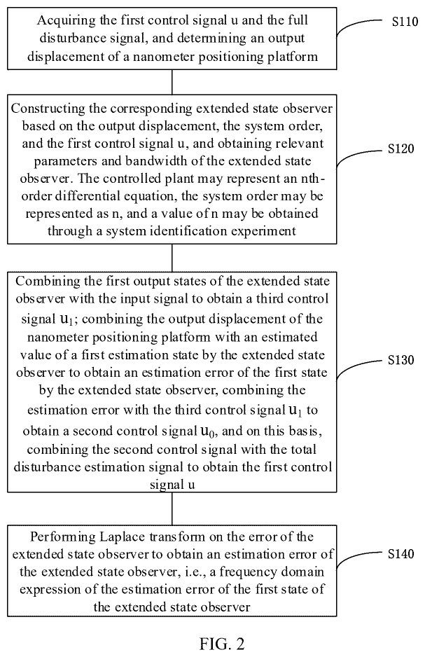

In an embodiment, referring to FIG. 2 to FIG. 4, constructing the extended state observer based on the state space model of the controlled plant may include step 110 to step 140.

Step 110 may include acquiring the first control signal u and the total disturbance signal, and determining an output displacement of a nanometer positioning platform.

Step 120 may include constructing the corresponding extended state observer based on the output displacement, the system order, and the first control signal u, and obtaining relevant parameters and bandwidth of the extended state observer. The controlled plant may represent an nth-order differential equation, the system order may be represented as n, and a value of n may be obtained through a system identification experiment.

Step 130 may include combining the first output states of the extended state observer with the input signal to obtain a third control signal u₁; combining the output displacement of the nanometer positioning platform with an estimated value of a first estimation state by the extended state observer to obtain an estimation error of the first state by the extended state observer, combining the estimation error with the third control signal u to obtain a second control signal u₀, and on this basis, combining the second control signal with the total disturbance estimation signal to obtain the first control signal u.

Step 140 may include performing Laplace transform on the error of the extended state observer to obtain an estimation error of the extended state observer, i.e., a frequency domain expression of the estimation error of the first state of the extended state observer.

It should be noted that the combination refers to arithmetic processing of the signal. In some embodiments, subtraction may be performed on the output displacement of the nanometer positioning platform and the estimated value of the first state by the extended state observer to obtain the estimation error of the first state by the extended state observer, subtraction may be performed on the estimation error and the third control signal to obtain the second control signal, and on this basis, subtraction may be performed on the second control signal and the total disturbance estimation signal to obtain the first control signal.

In the related art, an active disturbance rejection method of an extended state observer does not provide a method for explicitly analyzing the estimation error and eliminating such an error. In the present disclosure, through the above steps, the output states of the extended state observer are definitely introduced to an input end through the extended state observer to serve as feedback, and finally act on the state space model describing the controlled plant. Therefore, the estimation error of the total disturbance signal by the extended state observer can be effectively eliminated, thereby improving an anti-interference capability of a control system, which is of great significance in practical application of the nanometer positioning platform.

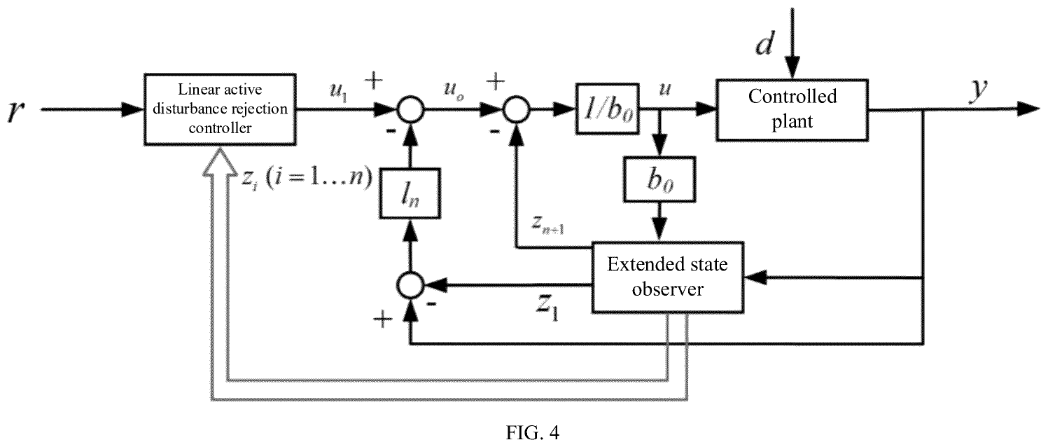

Referring to FIG. 4, the first control signal and the total disturbance signal may be applied to the state space model describing the controlled plant, which is represented as:

$${y}^{( n )} = f + bu \qquad ( 1 )$$

y⁽ⁿ⁾ may represent the controlled plant and represent the nth-order differential equation, the system order may be represented as n, and the value of n may be obtained by the system identification experiment. \dot{y} may represent the first derivative of the output displacement y, and y⁽ⁿ⁻¹⁾ may represent an (n−1)-th derivative of the output displacement y.

y may represent the output displacement and be directly measured by a sensor. u may represent the first control signal, i.e., a control input to the controlled plant, f may represent the total disturbance signal (including disturbance d), the total disturbance signal f may represent an unknown disturbance, b may represent a gain of the first control signal and be usually unknown, and b₀ may represent an estimation of b and be obtained by experiments.

When the extended state observer is constructed, since a structural formula of the extended state observer is fixed, the parameters of the state observer may need to be determined. Therefore, estimated values z₁, . . . , zₙ of the states of all orders of the controlled plant and an estimated value zₙ₊₁ of the total disturbance signal f may be obtained.

In an embodiment, it is assumed that an actual state of the controlled plant is defined as the output displacement and derivatives of all orders of the output displacement, which are represented as the states of all orders of the controlled plant: x₁=y, . . . , xₙ=y⁽ⁿ⁻¹⁾,xₙ₊₁=f. In order to facilitate a design of the extended state observer, the number of the states of all orders may be increased from n to n+1. The corresponding extended state observer may have n+1 orders, contain n+1 state variables, and be represented as:

$$\{ \begin{matrix}{\dot{z}}_{1} = {z}_{2} + {l}_{1} ( y - {z}_{1} ) \\ ⋮ \\ {\dot{z}}_{n} = {z}_{n + 1} + {l}_{n} ( y - {z}_{1} ) + bu \\ {\dot{z}}_{n + 1} = {l}_{n + 1} ( y - {z}_{1} ) \\ \hat{y} = {z}_{1}\end{matrix}$$

ŷ may represent an estimation of the output displacement, f may represent the total disturbance signal, zᵢ(i=1 . . . n+1) may represent first output states of the extended state observer, Żᵢ may represent a first derivative of first output states zᵢ(i=1 . . . n+1) of the extended state observer,

$${l}_{i} = \frac{( n + 1 ) !}{i ! ( n + 1 - i ) !} {ω}_{o}^{i}$$

may represent a parameter of the extended state observer, ωₒ may represent the bandwidth of the extended state observer which is usually 4-5 times a control bandwidth, and the control bandwidth may be selected by a requirement for rapidity of the output displacement. u may represent the first control signal, and when ωₒ approaches a preset threshold, output states of the extended state observer may approach the actual states of the controlled plant i.e., zᵢ→xᵢ(i=1 . . . n).

z₁ ay give an estimation of the output displacement y, z₂ may give an estimation of \dot{y}, z₃ may give an estimation of ÿ, and so on. The last state variable zₙ₊₁ may be an estimation of the total disturbance signal f in equation (1).

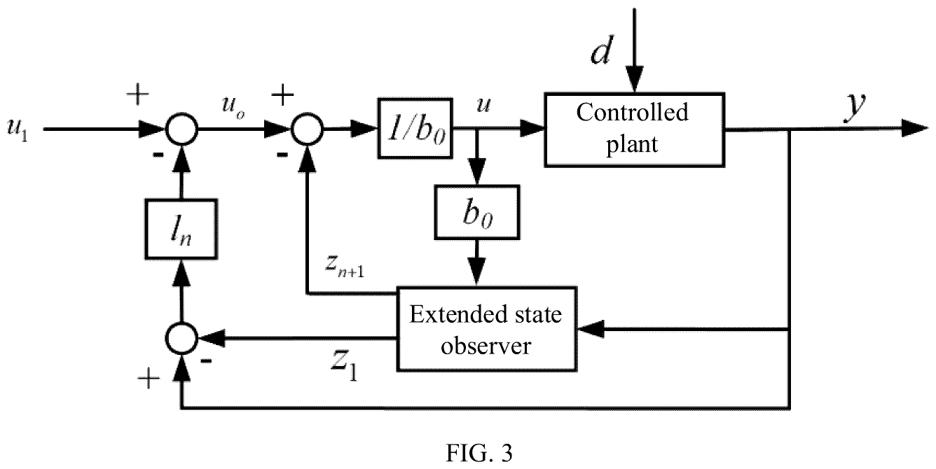

Referring to FIG. 3, after the extended state observer is constructed, the estimated value zₙ₊₁ of the total disturbance signal f may be fed back to the input end, so as to eliminate the majority of the total disturbance signal f. Then, lₙ(y−z₁) may be fed back to the input end to compensate for the estimation error to remove a residual part of the total disturbance signal f. In this case, the controlled plant may be changed from y⁽ⁿ⁾=f+bu to y⁽ⁿ⁾˜u₁.

On this basis, the linear active disturbance rejection controller is designed as:

$${u}^{′} = \frac{{k}_{1} ( r - {z}_{1} ) - {k}_{2} {z}_{2} - … - {k}_{n} {z}_{n} - {l}_{n} {e}_{1}}{{b}_{0}}$$

kᵢ(i=1 . . . n) may represent a parameter and selected according to requirements for a performance of a closed-loop control system, and b₀ represents a gain of the first control signal.

In an embodiment, the estimation error of the extended state observer may be obtained by the following process.

It is assumed that the first control signal is represented as:

$$u = ( {u}_{0} - \hat{f} ) / {b}_{0}$$

First output displacement may be obtained in conjunction with the state space model, and the

first output displacement may be represented as:

$${y}^{( n )} = {u}_{o} + {d}_{1} = {u}_{o} + f - \hat{f}$$

u₀ may represent the second control signal, \hat{f}=Zₙ₊₁ may represent the estimated value of the total disturbance signal f, d₁ may represent residual disturbance, and b₀ represents a gain of the first control signal.

The error dynamics of the extended state observer may be represented as:

$$\{ \begin{matrix}{e}_{1} = y - {z}_{1} \\ {\dot{e}}_{1} = {e}_{2} - {l}_{1} {e}_{1} \\ ⋮ \\ {\dot{e}}_{n} = {d}_{1} - {l}_{n} {e}_{1} \\ {\dot{e}}_{n + 1} = h - {l}_{n + 1} {e}_{1}\end{matrix}$$

The above formula may further be converted into:

$${e}_{1}^{( n )} = - {l}_{1} {e}_{1}^{( n 1 )} - {l}_{2} {e}_{1}^{( n 2 )} - … - {l}_{n} {e}_{1} + {d}_{1} .$$

Laplace transform may be performed on the first state estimation error of the extended state observer to obtain a transfer function of the estimation error, i.e.,

$${E}_{1} ( s ) = \frac{{D}_{1} ( s )}{{s}^{n} + {l}_{1} {s}^{n - 1} + {l}_{2} {s}^{n - 2} + … + {l}_{n}} ,$$

E₁(s) and D₁(s) represent Laplace transform of e₁ and d₁, respectively, and lₙe₁ represents a low frequency approximation of the residual disturbance d₁.

In an embodiment, the linear active disturbance rejection controller with error-compensated extended state observer may be represented as:

$${u}^{′} = \frac{{k}_{1} ( r - {z}_{1} ) - {k}_{2} {z}_{2} - … - {k}_{n} {z}_{n} - {l}_{n} {e}_{1}}{{b}_{0}}$$

kᵢ(i=1 . . . n) may represent the parameter of the linear active disturbance rejection controller, zᵢ(i=1 . . . n) may represent the output states of the extended state observer, and b₀ may represent a gain of the first control signal.

In order to further illustrate superiority of the error-compensated extended state observer, the following comparative analysis may be performed, and it is assumed that the second derivative of the output displacement y is represented as:

$$\ddot{y} = {\underbrace{{\dot{y}}^{3} + y + d}}_{f} + {u}^{′} ,$$

the linear active disturbance rejection controller with error-compensated extended state observer is represented as: u′=kₚ(r−z₁)−k_{d}z₂−l₂e₁, y may represent the output displacement, \dot{y} may represent a first derivative of the output displacement y, ÿ may represent the second derivative of the output displacement y, kₚ=ω_{c}², k_{d}=2ω_{c}, ω_{c} may represent a control bandwidth, the disturbance d may include a square wave signal, r represents the input signal of the linear active disturbance rejection controller, and z₁ and z₂ represent the output states of the extended state observer. System anti-disturbance capabilities in the following 3 cases may be compared when u of the linear active disturbance rejection controller is used as the control signal and square-wave-type disturbance is applied at t=4 sec and t=6 see (a disturbance amplitude is 20).

First solution: the total disturbance f is known, and a conventional extended state observer is adopted.

Second solution: the total disturbance f is unknown, and the conventional extended state observer is adopted.

Third solution: the total disturbance f is unknown, and the error-compensated state observer in the present disclosure is adopted.

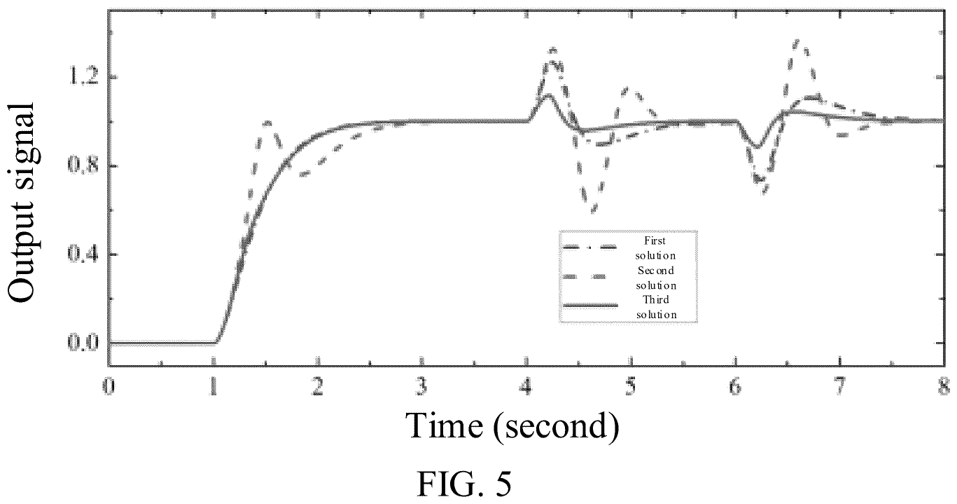

Comparative results may be shown in FIG. 5.

It follows that the error-compensated extended state observer can achieve a control effect similar to that in the case where the disturbance is known, even in the case where the disturbance is completely unknown.

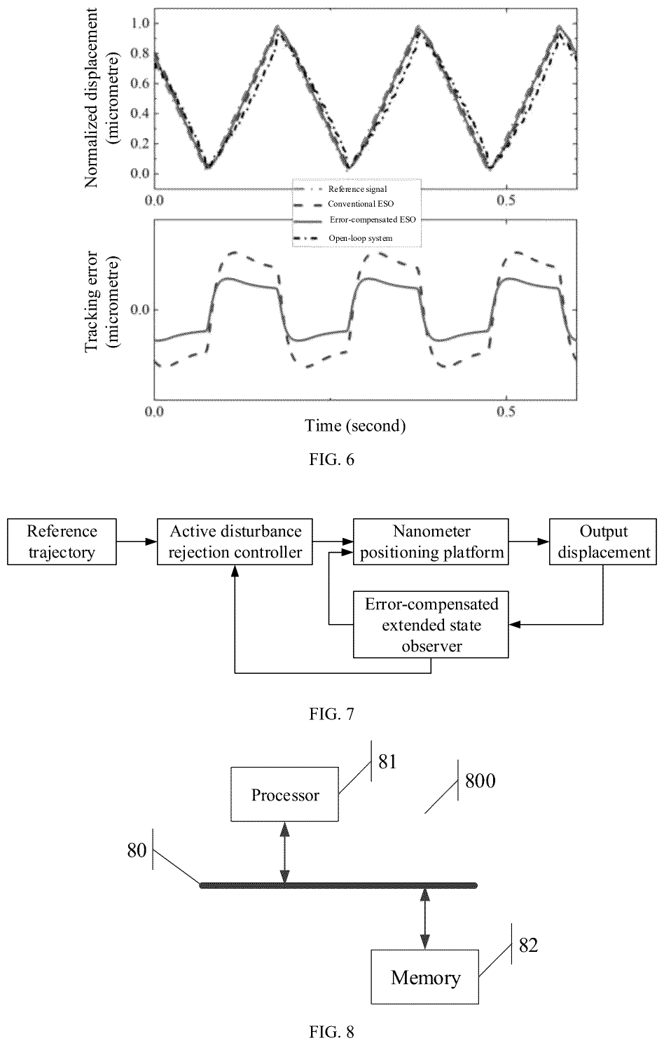

FIG. 6 shows a comparison of triangle wave tracking results of the nanometer positioning platform under different control methods. The nanometer positioning platform has a resonance frequency of 100 Hz, a damping ratio of 0.02, an ESO bandwidth of 200 Hz, and a control bandwidth of 100 Hz. It can be seen that hysteresis and resonance characteristics of the nanometer positioning platform can be effectively compensated under the condition of adopting closed-loop control. Furthermore, active disturbance rejection control error curves based on the conventional ESO (extended state observer) and the EC-ESO (error-compensated extended state observer) may be compared. It can be seen that the method according to the present disclosure can reduce a tracking error by more than 50% under the condition that the control parameters are completely the same, thereby verifying innovation and effectiveness of the present disclosure.

In conclusion, in the present disclosure, an estimation capability of the extended state observer may be greatly improved on the premise that the bandwidth of the extended state observer is not increased. The error-compensated extended state observer may be combined with the active disturbance rejection control, thus further improving a tracking performance of the active disturbance rejection control.

### Second Embodiment

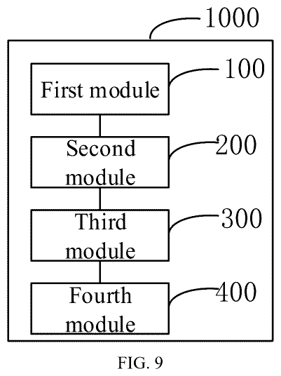

An active disturbance rejection control system 1000 based on an error-compensated extended state observer is provided, and referring to FIG. 9, includes a first module 100, a second module 200, a third module 300, and a fourth module 400.

The first module 100 is configured for constructing an extended state observer based on a state space model of a controlled plant; allowing a linear active disturbance rejection controller to acquire an input signal and first output states of the extended state observer and output a first control signal.

The second module 200 is configured for converting the controlled plant into an integrator-chain form based on the first control signal, a total disturbance signal, and an estimation error of the extended state observer, and obtaining an output displacement signal based on the controlled plant.

The third module 300 is configured for inputting the output displacement signal and the control input signal to the extended state observer, and outputting second output states of the extended state observer.

The fourth module 400 is configured for feeding the second output states back to the linear active disturbance rejection controller and the state space model of the controlled plant.

The present disclosure further provides another alternatively embodiment of the active disturbance rejection control system 1000 based on an error-compensated extended state observer, and in this embodiment, the active disturbance rejection control system 1000 based on an error-compensated extended state observer includes: a processor 81. The processor 81 is configured to execute the above program modules stored in a memory 82: the first module 100, the second module 200, the third module 300, and the fourth module 400.

Based on the same inventive concept, an embodiment of the present disclosure further provides an electronic device, the electronic device can implement the function of active disturbance rejection control based on the error-compensated extended state observer, and the electronic device includes: at least one processor and a memory 82 connected with the at least one processor 81. In the embodiment of the present disclosure, a specific connection medium between the processor 81 and the memory 82 is not limited, and in FIG. 8, as an example, the processor 81 is connected with the memory 82 through a bus 80. The bus 80 is represented by a thick line in FIG. 8, and connection manners between other components are merely illustrative, and the present disclosure is not limited thereto. The bus 80 may include an address bus, a data bus, a control bus, or the like, and for ease of illustration, the bus is represented by one thick line in FIG. 8, which does not indicate only one bus or one type of buses. Alternatively, the processor 81 may be referred to as a controller, and the name is not limited.

In the embodiment of the present disclosure, the memory 82 stores instructions executable by the at least one processor 81, and the at least one processor 81 may execute the EGR control method discussed above by executing the instructions stored by the memory 82. The processor 81 may implement the functions of the modules in the apparatus shown in FIG. 7.

The processor 81 is a control center of the apparatus, may be connected with various parts of the entire control device by using various interfaces and lines, and performs various functions of the apparatus and processes data by operating or executing the instructions stored in the memory 82 and calling data stored in the memory 82, thereby performing overall monitoring of the apparatus.

In a possible design, the processor 81 may include one or more processing units, the processor 81 may integrate an application processor and a modem processor, the application processor handles primarily an operating system, a user interface, applications, or the like, and the modem processor handles primarily wireless communication. It may be appreciated that the modem processor described above may not be integrated into the processor 81. In some embodiments, the processor 81 and the memory 82 may be implemented on the same chip, and in some embodiments, the processor 81 and the memory 82 may be implemented separately on separate chips.

The processor 81 may be a general-purpose processor, such as a central processing unit (CPU), a digital signal processor, an application specific integrated circuit, a field programmable gate array or other programmable logic devices, discrete gates or transistor logic devices, and discrete hardware components, that may implement or perform the methods, steps, and logic blocks disclosed in the embodiments of the present disclosure. The general-purpose processor may be a microprocessor or any conventional processor, or the like. The steps of the EGR control method according to the embodiment of the present disclosure may be directly implemented by a hardware processor, or implemented by a combination of hardware and software modules in the processor.

The memory 82, which is a non-volatile computer-readable storage medium, may be configured to store non-volatile software programs, non-volatile computer-executable programs, and modules. The memory 82 may include at least one type of storage media, and may include, for example, a flash memory, a hard disk, a multimedia card, a card-type memory, a random access memory (RAM), a static random access memory (SRAM), a programmable read only memory (PROM), a read only memory (ROM), an electrically erasable programmable read-only memory (EEPROM), a magnetic memory, a magnetic disk, an optical disk, or the like. The memory 82 is any other medium that can be configured to carry or store desired program codes in the form of instructions or data structures and can be accessed by a computer, but is not limited thereto. The memory 82 in the embodiments of the present disclosure may also be circuitry or any other apparatus capable of achieving a storing function and is configured to store program instructions and/or data.

By designing and programming the processor 81, codes corresponding to the EGR control method described in the foregoing embodiments can be fixed into the chip, so that the chip can execute the steps of the EGR control method according to the embodiment shown in FIG. 4 when running. How to design and program the processor 81 is well known to those skilled in the art and is not repeated herein.

Based on the same inventive concept, the embodiments of the present disclosure also provide a storage medium storing computer instructions which, when executed on a computer, cause the computer to perform the EGR control method discussed above.

In some possible embodiments, the various aspects of the EGR control method according to the present disclosure may also be implemented in the form of a program product including program codes for causing the control device to carry out the steps of the EGR control method according to various exemplary embodiments of the present disclosure described above in the specification when the program product is run on the apparatus.

Those skilled in the art may understand that the present disclosure may be embodied by a method, a system or a computer program product. Therefore, the present disclosure may be embodied completely by hardware, software or by a combination of software and hardware. In addition, the present disclosure may be embodied by a computer program product implemented in one or more computer available storage media including computer available program codes (including but not limited to a disk memory, a CD-ROM, an optical memory, etc.).

The present disclosure is described in conjunction with the flow chart and/or block diagram of the method, device (system) and computer program product according to the embodiments of the present disclosure. It should be understood that each flow and/or block of the flow chart and/or block diagram or a combination of each flow and/or block of the flow chart and/or block diagram may be implemented by the computer program instructions. These computer program instructions may be provided to a general purpose computer, a dedicated computer, an embedded processor or the processors of other programmable data processing devices to make a machine, so as to make the instructions performed by the processor of the computer or other programmable data processing devices produce an apparatus for implementing the functions prescribed in one or more flows in the flow chart and/or one or more blocks in the block diagram.

These computer program instructions may further be stored in a computer readable memory capable of leading the computer or other programmable data processing devices to work in a specific manner, such that the instructions stored in the computer readable memory may produce an article of manufacture including an instruction apparatus, where the instruction apparatus implements the functions prescribed in one or more flows in the flow chart and/or one or more blocks in the block diagram.

These computer program instructions may further be loaded into a computer or other programmable data processing devices, such that a series of operation steps may be performed in the computer or other programmable devices, so as to produce computer-implemented processing, such that the instructions performed in the computer or other programmable devices may provide the steps for implementing the functions prescribed in one or more flows in the flow chart and/or one or more blocks in the block diagram.

In addition, it should be noted that the specific embodiments described in the present specification may be different in terms of the shapes and names of the parts and components, or the like. All equivalent or simple changes made according to the structures, features and principles which are described in the patent conception are included in the protection scope of the present disclosure. Those skilled in the art to which the present disclosure belongs can make various modifications or additions to the described specific embodiments or make substitutions in similar manners, all of which should fall within the protection scope of the present disclosure as long as they do not deviate from the structure of the present disclosure or exceed the scope defined by the claims.

What is claimed is:

1. An active disturbance rejection control method based on an error-compensated extended state observer, comprising the following steps:
constructing an extended state observer based on a state space model of a controlled plant; allowing a linear active disturbance rejection controller to acquire an input signal and first output states of the extended state observer and output a first control signal;
converting the controlled plant into an integrator-chain form based on the first control signal, a total disturbance signal, and an estimation error of the extended state observer, and obtaining an output displacement signal based on the controlled plant;
inputting the output displacement signal and the input signal to the extended state observer, and outputting second output states of the extended state observer; and
feeding the second output states back to the linear active disturbance rejection controller and the state space model of the controlled plant.

2. The active disturbance rejection control method based on the error-compensated extended state observer of claim 1, wherein constructing the extended state observer based on the state space model of the controlled plant comprises the following steps:
acquiring the first control signal and the total disturbance signal, and determining an output displacement of a nanometer positioning platform;
constructing the corresponding extended state observer based on the output displacement, the system order, and the first control signal, and obtaining relevant parameters and bandwidth of the extended state observer;
combining the first output states of the extended state observer with the input signal to obtain a third control signal; combining the output displacement of the nanometer positioning platform with a first estimation state of the extended state observer to obtain an estimation error of the extended state observer about a first state;
combining the estimation error of the first state with the third control signal to obtain a second control signal;
combining the second control signal with the total disturbance signal to obtain the first control signal; and
performing Laplace transform on an error equation set of the first state of the extended state observer to obtain a frequency domain expression of the estimation error of the first state of the extended state observer.

3. The active disturbance rejection control method based on the error-compensated extended state observer of claim 1, wherein the state space model is represented as: y⁽ⁿ⁾=f+b₀u,
wherein y represents the output displacement, u represents the first control signal, f represents the total disturbance signal, and b₀ represents a gain of the first control signal.

4. The active disturbance rejection control method based on the error-compensated extended state observer of claim 1,
wherein an actual state of the controlled plant is defined as the output displacement and derivatives of all orders of the output displacement, which are represented x₁=y, . . . ,xₙ=y⁽ⁿ⁻¹⁾,xₙ₊₁=f,
the corresponding extended state observer is represented as:
$$\{ \begin{matrix}{\dot{z}}_{1} = {z}_{2} + {l}_{1} ( y - {z}_{1} ) \\ ⋮ \\ {\dot{z}}_{n} = {z}_{n + 1} + {l}_{n} ( y - {z}_{1} ) + bu \\ {{z}^{`}}_{n + 1} = {l}_{n + 1} ( y - {z}_{1} ) \\ \hat{y} = {z}_{1}\end{matrix}$$
wherein ŷ represents an estimation of the output displacement, f represents the total disturbance signal, zᵢ(i=1 . . . n+1) represents the first output states of the extended state observer,
$${l}_{i} = \frac{( n + 1 ) !}{i ! ( n + 1 - i ) !} {ω}_{o}^{i}$$
represents a parameter of the extended state observer, ωₒ represents a bandwidth of the extended state observer, u represents the first control signal, and when ωₒ approaches a preset threshold, the first output states of the extended state observer approaches the actual state of the controlled plant, that is, zᵢ→xᵢ(i=1 . . . n).

5. The active disturbance rejection control method based on the error-compensated extended state observer of claim 2, wherein it is assumed that the first control signal is represented as:
$$u = ( {u}_{0} - \hat{f} ) / {b}_{0}$$
a first output displacement is obtained in conjunction with the state space model, and the first output displacement is represented as:
$${y}^{( n )} = {u}_{o} + {d}_{1} = {u}_{o} + f - \hat{f}$$
wherein u₀ represents the second control signal, \hat{f} represents an estimated value of the total disturbance signal f, d₁ represents residual disturbance, and b₀ represents a gain of the first control signal;
the estimation error of the first state relates to the output displacement is represented as follows:
$${e}_{1}^{( n )} = - {l}_{1} {e}_{1}^{( n 1 )} - {l}_{2} {e}_{1}^{( n 2 )} - … - {l}_{n} {e}_{1} + {d}_{1}$$
Laplace transform is performed on the estimation error of the first state to obtain a transfer function between the estimation error of the first state and residual disturbance:
$${E}_{1} ( s ) = \frac{{D}_{1} ( s )}{{s}^{n} + {l}_{1} {s}^{n - 1} + {l}_{2} {s}^{n - 2} + … + {l}_{n}} ,$$
wherein
$${l}_{i} = \frac{( n + 1 ) !}{i ! ( n + 1 - i ) !} {ω}_{o}^{i} ( i = 1 , … , n + 1 )$$
represents a parameter of the extended state observer, ωₒ represents a bandwidth of the extended state observer, E₁(s) and D₁(s) represent Laplace transform of e₁ and d₁, respectively, and lₙe₁ represents a low frequency approximation of the residual disturbance d₁.

6. The active disturbance rejection control method based on an error-compensated extended state observer of claim 1, wherein the linear active disturbance rejection controller with error-compensated extended state observer is represented as:
$${u}^{′} = \frac{{k}_{1} ( r - {z}_{1} ) - {k}_{2} {z}_{2} - … - {k}_{n} {z}_{n} - {l}_{n} {e}_{1}}{{b}_{0}}$$
wherein kᵢ(i=1 . . . n) represents a parameter of the linear active disturbance rejection controller; zᵢ(i=1 . . . n) represents the first output states of the extended state observer, r represents the input signal of the linear active disturbance rejection controller, b₀ represents a gain of the first control signal, and lₙe₁ represents a low frequency approximation of a residual disturbance d₁.

7. The active disturbance rejection control method based on an error-compensated extended state observer according to claim 1,
wherein it is assumed that a second derivative of the output displacement y is represented as:
$$\ddot{y} = {\underbrace{{\dot{y}}^{3} + y + d}}_{f} + {u}^{′} ;$$
the linear active disturbance rejection controller with error-compensated extended state observer is represented as: u′=kₚ(r−z₁)−k_{d}z₂−l₂e₁
wherein y represents the output displacement, \dot{y} represents a first derivative of the output displacement y, ÿ represents the second derivative of the output displacement y, kₚ=ω_{c}^{s}, k_{d}=2ω_{c}, ω_{c} represents a control bandwidth, the disturbance d comprises a square wave signal, r represents the input signal of the linear active disturbance rejection controller, and z₁ and z₂ represent the output states of the extended state observer.

8. An active disturbance rejection control system based on an error-compensated extended state observer, comprising:
means for allowing a linear active disturbance rejection controller to acquire an input signal and first output states of an extended state observer and output a first control signal;
means for constructing a state space model of the extended state observer for output displacement, converting a controlled plant into an integrator-chain form based on the first control signal, a total disturbance signal, and an estimation error of the extended state observer, and obtaining an output displacement signal based on the controlled plant;
means for inputting the output displacement signal and the input signal to the extended state observer, and outputting second output states of the extended state observer; and
means for feeding the second output states back to the linear active disturbance rejection controller and the state space model of the controlled plant.

9. A computer-readable storage medium, in which a computer program is stored, wherein the computer program is executed by a processor to implement the method of claim 1.

10. The computer-readable storage medium of claim 9, wherein constructing the extended state observer based on the state space model of the controlled plant comprises the following steps:
acquiring the first control signal and the total disturbance signal, and determining an output displacement of a nanometer positioning platform;
constructing the corresponding extended state observer based on the output displacement, the system order, and the first control signal, and obtaining relevant parameters and bandwidth of the extended state observer;
combining the first output states of the extended state observer with the input signal to obtain a third control signal; combining the output displacement of the nanometer positioning platform with a first estimation state of the extended state observer to obtain an estimation error of the extended state observer about a first state;
combining the estimation error of the first state with the third control signal to obtain a second control signal;
combining the second control signal with the total disturbance signal to obtain the first control signal; and
performing Laplace transform on an error equation set of the first state of the extended state observer to obtain a frequency domain expression of the estimation error of the first state of the extended state observer.

11. The computer-readable storage medium of claim 9, wherein the state space model is represented as: y⁽ⁿ⁾=f+b₀u,
wherein y represents the output displacement, u represents the first control signal, f represents the total disturbance signal, and b₀ represents a gain of the first control signal.

12. The computer-readable storage medium of claim 9,
wherein an actual state of the controlled plant is defined as the output displacement and derivatives of all orders of the output displacement, which are represented as x₁=y, . . . ,xₙ=y⁽ⁿ⁻¹⁾,xₙ₊₁=f,
the corresponding extended state observer is represented as:
$$\{ \begin{matrix}{\dot{z}}_{1} = {z}_{2} + {l}_{1} ( y - {z}_{1} ) \\ ⋮ \\ {\dot{z}}_{n} = {z}_{n + 1} + {l}_{n} ( y - {z}_{1} ) + bu \\ {{z}^{`}}_{n + 1} = {l}_{n + 1} ( y - {z}_{1} ) \\ \hat{y} = {z}_{1}\end{matrix}$$
wherein ŷ represents an estimation of the output displacement, f represents the total disturbance signal, zᵢ(i=1 . . . n+1) represents the first output states of the extended state observer,
$${l}_{i} = \frac{( n + 1 ) !}{i ! ( n + 1 - i ) !} {ω}_{o}^{i}$$
represents a parameter of the extended state observer, ωₒ represents a bandwidth of the extended state observer, u represents the first control signal, and when ωₒ approaches a preset threshold, the first output states of the extended state observer approaches the actual state of the controlled plant, that is, zᵢ→xᵢ(i=1 . . . n).

13. The computer-readable storage medium of claim 10, wherein it is assumed that the first control signal is represented as:
$$u = ( {u}_{0} - \hat{f} ) / {b}_{0}$$
a first output displacement is obtained in conjunction with the state space model, and the first output displacement is represented as:
$${y}^{( n )} = {u}_{o} + {d}_{1} = {u}_{o} + f - \hat{f}$$
wherein u₀ represents the second control signal, \hat{f} represents an estimated value of the total disturbance signal f, d₁ represents residual disturbance, and b represents a gain of the first control signal;
the estimation error of the first state of extended state observer relates to the first output displacement is represented as follows:
$${e}_{1}^{( n )} = - {l}_{1} {e}_{1}^{( n - 1 )} - {l}_{2} {e}_{1}^{( n - 2 )} - … - {l}_{n} {e}_{1} + {d}_{1}$$
Laplace transform is performed on the estimation error of the first state to obtain a transfer function between the estimation error of the first state and residual disturbance:
$${E}_{1} ( s ) = \frac{{D}_{1} ( s )}{{s}^{n} + {l}_{1} {s}^{n - 1} + {l}_{2} {s}^{n - 2} + … + {l}_{n}} ,$$
wherein
$${l}_{i} = \frac{( n + 1 ) !}{i ! ( n + 1 - i ) !} {ω}_{o}^{i} \\ ( i = 1 , … , n + 1 )$$
represents a parameter of the extended state observer, ωₒ represents a bandwidth of the extended state observer, E₁(s) and D₁(s) represent Laplace transform of e₁ and d₁, respectively, and lₙe₁ represents a low frequency approximation of the residual disturbance d₁.

14. The computer-readable storage medium of claim 9, wherein the linear active disturbance rejection controller with error-compensated extended state observer is represented as:
$${u}^{′} = \frac{{k}_{1} ( r - {z}_{1} ) - {k}_{2} {z}_{2} - … - {k}_{n} {z}_{n} - {l}_{n} {e}_{1}}{{b}_{0}}$$
wherein kᵢ(i=1 . . . n) represents parameter of the linear active disturbance rejection controller; zᵢ(i=1 . . . n) represents the first output states of the extended state observer; r represents the input signal of the linear active disturbance rejection controller, b₀ represents a gain of the first control signal, and lₙe₁ represents a low frequency approximation of a residual disturbance d₁.

15. The computer-readable storage medium of claim 9,
wherein it is assumed that a second derivative of the output displacement y is represented as:
$$\ddot{y} = {\underbrace{{\dot{y}}^{3} + y + d}}_{f} + u ;$$
the linear active disturbance rejection controller with error-compensated extended state observer is represented as:
$$u = {k}_{p} ( r - {z}_{1} ) - {k}_{d} {z}_{2} - {l}_{2} {e}_{1}$$
wherein y represents the output displacement, \dot{y} represents a first derivative of the output displacement y, ÿ represents the second derivative of the output displacement y, kₚ=ω_{c}², k_{d}=2ω_{c}, ω_{c} represents a control bandwidth, the disturbance d comprises a square wave signal, r represents the input signal of the linear active disturbance rejection controller, and z₁ and z₂ represent the output states of the extended state observer.

16. An active disturbance rejection control apparatus based on an error-compensated extended state observer, comprising a memory, a processor, and a computer program stored in the memory and running on the processor, wherein the processor implements the method of claim 1 when executing the computer program.

17. The active disturbance rejection control apparatus based on an error-compensated extended state observer of claim 16, wherein constructing the extended state observer based on the state space model of the controlled plant comprises the following steps:
acquiring the first control signal and the total disturbance signal, and determining an output displacement of a nanometer positioning platform;
constructing the corresponding extended state observer based on the output displacement, the system order, and the first control signal, and obtaining relevant parameters and bandwidth of the extended state observer;
combining the first output states of the extended state observer with the input signal to obtain a third control signal; combining the output displacement of the nanometer positioning platform with a first estimation state of the extended state observer to obtain an estimation error of the extended state observer about a first state;
combining the estimation error of the first state with the third control signal to obtain a second control signal;
combining the second control signal with the total disturbance signal to obtain the first control signal; and
performing Laplace transform on an error equation set of the first state of the extended state observer to obtain a frequency domain expression of the estimation error of the first state of the extended state observer.

18. The active disturbance rejection control apparatus based on an error-compensated extended state observer of claim 16, wherein the state space model is represented as: y⁽ⁿ⁾=f+b₀u,
wherein y represents the output displacement, u represents the first control signal, f represents the total disturbance signal, and b₀ represents a gain of the first control signal.

19. The active disturbance rejection control apparatus based on an error-compensated extended state observer of claim 16,
wherein an actual state of the controlled plant is defined as the output displacement and derivatives of all orders of the output displacement, which are represented as x₁=y, . . . ,xₙ=y⁽ⁿ⁻¹⁾,xₙ₊₁=f,
the corresponding extended state observer is represented as:
$$\{ \begin{matrix}{\dot{z}}_{1} = {z}_{2} + {l}_{1} ( y - {z}_{1} ) \\ ⋮ \\ {\dot{z}}_{n} = {z}_{n + 1} + {l}_{n} ( y - {z}_{1} ) + bu \\ {\dot{z}}_{n + 1} = {l}_{n + 1} ( y - {z}_{1} ) \\ \hat{y} = {z}_{1}\end{matrix}$$
wherein ŷ represents an estimation of the output displacement, f represents the total disturbance signal, zᵢ(i=1 . . . n+1) represents the first output states of the extended state observer,
$${l}_{i} = \frac{( n + 1 ) !}{i ! ( n + 1 - i ) !} {ω}_{o}^{i}$$
represents a parameter of the extended state observer, ωₒ represents a bandwidth of the extended state observer, u represents the first control signal, and when ωₒ approaches a preset threshold, the first output states of the extended state observer approaches the actual state of the controlled plant, that is, zᵢ→xᵢ(i=1 . . . n).

20. The active disturbance rejection control apparatus based on an error-compensated extended state observer of claim 17, wherein it is assumed that the first control signal is represented as:
$$u = ( {u}_{0} - \hat{f} ) / {b}_{0}$$
a first output displacement is obtained in conjunction with the state space model, and the first output displacement is represented as:
$${y}^{( n )} = {u}_{o} + {d}_{1} = {u}_{o} + f - \hat{f}$$
wherein u₀ represents the second control signal, \hat{f} represents an estimated value of the total disturbance signal f, d₁ represents residual disturbance, and b represents a gain of the first control signal;
the estimation error of the first state relates to the output displacement is represented as follows:
$${e}_{1}^{( n )} = - {l}_{1} {e}_{1}^{( n - 1 )} - {l}_{2} {e}_{1}^{( n - 2 )} - … - {l}_{n} {e}_{1} + {d}_{1}$$
Laplace transform is performed on the estimation error of the first state to obtain a transfer function between the estimation error of the first state and residual disturbance:
$${E}_{1} ( s ) = \frac{{D}_{1} ( s )}{{s}^{n} + {l}_{1} {s}^{n - 1} + {l}_{2} {s}^{n - 2} + … + {l}_{n}} ,$$
wherein
$${l}_{i} = \frac{( n + 1 ) !}{i ! ( n + 1 - i ) !} {ω}_{o}^{i} \\ ( i = 1 , … , n + 1 )$$
represents a parameter of the extended state observer, ωₒ represents a bandwidth of the extended state observer, E₁(s) and D₁(s) represent Laplace transform of e₁ and d₁, respectively, and lₙe₁ represents a low frequency approximation of the residual disturbance d₁.
